(19) United States
(12) Patent Application Publication
(10) Pub. No.: US 2011/0238999 A1
(43) Pub. Date: Sep. 29, 2011

(54) Internet Based E-Will Management System Using Certificate and Method Thereof

(75) Inventors: Kwangwoo Lee, Gyeonggi-do (KR); Dongho Won, Gyeonggi-do (KR); Seungjoo Kim, Gyeonggi-do (KR)

(73) Assignee: The Industry & Academic Cooperation in Chungnam National University (IAC), Daejeon (KR)

(21) Appl. No.: 12/775,352

(22) Filed: May 6, 2010

(30) Foreign Application Priority Data
Mar. 26, 2010 (KR) 10 2010 0027398
Apr. 21, 2010 (KR) 10-2010-0036935

(51) Int. Cl. H04L 9/32

(52) U.S. Cl. 713/178; 713/176

(57) ABSTRACT

Disclosed is an Internet based e-will management method in which a will is managed by making digital signatures using a certificate issued by a certificate authority through a will management server connected to a testator/testatrix terminal and a will executor terminal via a network, the method comprising: (a) making digital signatures on an application form and a will using a certificate by a testator/testatrix through the testator/testatrix terminal and transmitting the digitally signed application form and will to the management server by the testator/testatrix terminal; (b) receiving the digitally signed application form and will and verifying and storing the digital signatures of the application form and will by the management server; (c) confirming the death of the testator/testatrix by the management server; and (d) transmitting, upon confirmation of the death of the testator/testatrix, the digitally signed will to the will executor terminal by the management server.

### CROSS-REFERENCE TO RELATED APPLICATION

This application claims priority to and the benefit of Korean Patent Application No. 2010-0027398 filed on Mar. 26, 2010 and Korean Patent Application No. 2010-0036935 filed on Apr. 21, 2010, the disclosures of which are incorporated herein by reference in their entireties.

### BACKGROUND

1. Field of the Invention

The invention relates to an e-will management system that ensures non-repudiation by allowing a testator/testatrix to make digital signatures on an application form and a will using a certificate issued by a certificate authority, and a method thereof.

The invention also relates to an e-will management system that acquires a time stamp of a will on which a digital signature is made before the expiration date of a certificate used in the will and stores the time stamp for a long time.

The invention also relates to an e-will management system that provides non-repudiation by allowing the testator/testatrix to make a digital signature on a will written in the form of an autograph or multimedia such as voices and videos using a certificate issued by a certification authority.

2. Discussion of Related Art

In recent years, it has become more important to draw up a will well in advance of the death of an individual. A will is the only way for a person to transfer a message to his/her acquaintances after his/her death. If a person dies without a will, his/her inheritance may cause trouble among heirs.

Thus, when a person leaves his/her property to his/her family, acquaintances, or friends, it is important to draw up a will to fairly distribute the property. It is important to draw up a document in the most efficient way in order to properly reflect what a testator/testatrix wishes to be done after his/her death.

A general will is written in the form of a paper document by a testator/testatrix or his/her agent, and this method entails considerable cost burden and is inconvenient due to agent fees and miscellaneous costs.

In order to solve these problems, various Internet based will services have been suggested (refer to References 1 to 6). However, since these services provide only very limited functions in relation to drawing up of wills, they have difficulty in being legally accepted.

Meanwhile, technologies for drawing up and managing a will using an Internet communication network have been suggested, one example of such being disclosed in Korean Patent Laid-Open No. 10-2007-0108996 titled “System for Drawing Up a Will Using an Internet Communication Network and a Method thereof” (hereinafter, referred to as “Prior Art 1”). Prior Art 1 suggests a technology of receiving information necessary for a user connected to an Internet communication network to draw up a will and then drawing up a will, performing a procedure of authenticating the written will by a certificate authority server, storing and managing the written and authenticated will, making the written and authenticated will available online or transmitting the same through an Internet communication network, and receiving information related thereto from a public authority service after the death of a testator/testatrix.

However, since Prior Art 1 uses a certificate in the form of paper and requires a testator/testatrix to sign the will by hand, it merely simplifies and computerizes a conventional method of drawing up and managing a will offline. Moreover, since Prior Art 1 uses a certificate authority (certificate authority server), it entails additional authentication costs.

Recently, Chien et al. (Hung-Yu Chien and Ru-Yu Lin, “The Study of Secure E-Will System on the Internet”, Journal of Information Science and Engineering 25, 877-893, 2009) have suggested two types of e-will (electronic will) writing methods, i.e. a holographic e-will system and a sealed e-will system as Internet based will writing systems. The methods suggested by Chien et al. are safe and are known to satisfy the Chinese Civil Law, but have some disadvantages.

As can be seen in FIG. 1A, the e-will service method of Chien et al. includes a system setting step, a key registration step, a will creation step, a death certificate issuing and submitting step, and a will unsealing step.

In the system setting step, a trusted authority TA (or court) sets system parameters E, q, G₁, G₂, e, H₁, H₂, P, and P_{TA}. When G₁ is a group on an elliptical curve, G₁ and G₂ are two groups having the order of a prime number q, and when P is a producer of G₁, a function H₁ corresponds to the ID of a user to one point of the group G₁. Assume that a coded Hash function H₂ is defined as H2: G2→{0,1}m and e is defined as a bilinear pairing. Then, the trusted authority TA selects an arbitrary integer S_{TA} as its secret key and calculates a public key of the system, i.e. PA=S_{TA}·P.

In the key registration step, the elements of the system need to be registered in the trusted authority TA to acquire their private keys. The public key of a testator/testatrix is Q_{A}. Moreover, the trusted authority TA, a doctor D, and a hospital H all need to be registered in the trusted authority TA to acquire their private keys.

In the will creation step, the testator/testatrix A fills out an application form and submits it to the trusted authority TA. After the will is drawn up and dated, the testator/testatrix A signs the will and the application form. Finally, the testator/testatrix A submits the will and the application form to the trusted authority TA, and the trusted authority TA verifies the signed will and application form. If the signatures are successfully verified, the trusted authority TA signs the application form and provides a missive L″ for certification to the testator/testatrix.

In the step of issuing and submitting a death certificate DC to relatives, a doctor diagnoses the cause of death after the death of the testator/testatrix, and issues a digital death certificate DC to his/her relative. The death certificate contains a digital signature S^{D} of the doctor and a digital signature S^{H} of the hospital. The hospital transmits the death certificate DC and the digital signatures S^{D} and S^{H} to the relative of the testator/testatrix. The relative submits the digital death certificate DC and the signatures S^{D} and S^{H} to the court and requests that the will be unsealed.

In the will unsealing step, the trusted authority TA verifies the digital death certificate DC and the signatures S^{D} and S^{H} of the doctor and the hospital. The verification method is as follows. IBSV_{QD}((S^{D}), (DC)) and IBSV_{QH}((S^{H}, (DC,S^{D}) are verified. The purpose of IBSV_{QD}((S^{D}), (DC)) is to verify the digital signatures of the digital death certificate DC to return a result value indicating success or failure.

If the digital death certificate DC and the digital signatures are verified properly, the trusted authority TA transmits the will M to the relative of the testator/testatrix.

As can be seen in FIG. 1B, differently from a handwriting e-will service method, the sealed e-will service method of Chien et al. allows an e-will to be sealed using a secret key of a trusted authority TA. Hereinafter, only the differences between the method of Chien et al. and the handwriting e-will service method will be described.

That is, in the system setting step, a trusted authority TA sets a system parameter, selects an arbitrary integer S_{TA} as a secret key of the trusted authority TA, and calculates a public key of the system, i.e. P_{TA}=S_{TA}·P.

In the will creation step, the testator/testatrix fills out an application form and obtains a sealed will C using a symmetric key k to encrypt the contents of the will. The symmetric key k is encrypted to a public key QADeath using a public sealing algorithm. Then, the testator/testatrix transmits the sealed will C, the encrypted symmetric key EncQADeath (k), and the application form L to the trusted authority TA.

After a court verifies whether or not the digital signature of the testator/testatrix is contained properly, it transmits the sealed will C and the application form L to two or more witnesses X and Y designated by the testator/testatrix to receive their digital signatures and verifies whether or not they are made properly.

Finally, in the will unsealing step, the trusted authority TA creates a private key, i.e. S_{ADeath}=S_{TA}, and uses the created private key to calculate the encrypted symmetric key (=Enc_{QADeath} (k)). IBD or IBE refers to a function for decryption or encryption based on an ID. The symmetric key k is used to unseal the sealed will C, the will and the signature, i.e. M=(m∥S^{A}) are transferred to his/her relative.

The method of Chien et al. fails to provide non-repudiation and also fails to suggest a will signature verification method.

That is, the method of Chien et al. fails to satisfy requirements for non-repudiation. The effective digital signature of a will verifies that it is created by an actual testator/testatrix, and also verifies that the will has not been changed during transmission. In the method of Chien et al., the trusted authority TA is assumed to be a court and is regarded as a trusted third party TTP. Thus, the trusted authority TA knows the private key of the user. For this reason, in the method of Chien et al., the trusted authority TA can create a signature of a testator/testatrix.

Moreover, the ID based digital signature of Chien et al. does not have legal force in any country. As a result, the method of Chien et al. does not have legal force based on a digital signature law.

In addition, the method of Chien et al. fails to provide a long-term signature validation method for a digital signature. This means that it becomes difficult to verify the availability of a will of a testator/testatrix if the available term for the key used in a digital signature expires after his/her death.

In general, the integrity of electronic documents is guaranteed by a digital signature. However, it is impossible to verify a digital signature if the available term for a certificate expires or the certificate is disused.

### SUMMARY OF THE INVENTION

The prevent invention has been made in an effort to solve the above-described problems associated with the prior art, and an object of the invention is to provide an Internet based e-will management system and method in which digital signatures are made on an application form and a will using certificates issued by certificate authorities to provide non-repudiation. In particular, the invention is useful in development of an Internet based e-will management system in which digital signatures are kept for a long time using a timestamp for an e-will which was digitally signed before the expiration date of a certificate used in the digitally signed will.

It is another object of the invention to provide an Internet based e-will management system and method in which digital signatures are kept for a long time using a timestamp for an e-will which was digitally signed before the expiration date of a certificate used in the digitally signed will.

According to an aspect of the invention for achieving the above object, there is provided an Internet based e-will management method in which a will is managed by making digital signatures using a certificate issued by a certificate authority through a will management server connected to a testator/testatrix terminal and a will executor terminal via a network, the method comprising: (a) making digital signatures on an application form and a will using a certificate by a testator/testatrix through the testator/testatrix terminal and transmitting the digitally signed application form and will to the management server by the testator/testatrix terminal; (b) receiving the digitally signed application form and will and verifying and storing the digital signatures of the application form and will by the management server; (c) confirming the death of the testator/testatrix by the management server; and (d) transmitting, upon confirmation of the death of the testator/testatrix, the digitally signed will to the will executor terminal by the management server.

According to another aspect of the invention, there is provided an Internet based e-will management method in which a will is managed by making digital signatures using a certificate issued by a certificate authority through a will management server connected to a testator/testatrix terminal and a will executor terminal via a network, the method comprising the step of: (a) making digital signatures on an application form and a will using a certificate by a testator/testatrix through the testator/testatrix terminal and transmitting the digitally signed application form and will to the management server together with a secret key for encrypting the will by the testator/testatrix terminal; (b) receiving the digitally signed application form and will and the secret key and verifying and storing the digital signatures of the application form and will by the management server; (c) confirming the death of the testator/testatrix by the management server; and (d) transmitting, upon confirmation of the death of the testator/testatrix, the digitally signed will and the secret key to the will executor terminal by the management server.

In step (a), the testator/testatrix terminal may encrypt the secret key using a public key of the management server, and in step (d), the management server may decrypt the encrypted secret key using its own private key and then transmit the decrypted secret key.

The Internet based e-will management method may further comprise the steps of: (b2) making a secondary digital signature on the application form using the certificate of the management server and transmitting the secondary digital signature to the testator/testatrix terminal by the management server after step (b), the application form still including the digital signature on the application form; and (b3) verifying the secondary digital signature by the testator terminal.

In step (c), the management server may receive a digitally signed death certificate from a server of a death confirmation authority and may confirm the death of the testator/testatrix by verifying the digital signature of the death certificate.

In step (c), the digitally signed death certificate may be transmitted via the will executor terminal.

When the server of the death confirmation authority is a server of a medical institution, the digitally signed death certificate may be a death certificate digitally signed using certificates of a doctor and a hospital.

The digitally signed death certificate of the testator/testatrix may be created by making a first digital signature on the death certificate of the testator/testatrix using the certificate of the doctor and making a secondary digital signature on the death certificate using the certificate of the medical institution, the death certificate still including the first digital signature.

The Internet based e-will management method may further comprise the steps of: (b1) transmitting the digitally signed application form and will to at least two witness terminals by the management server after step (b); (b2) making secondary digital signatures on the application form and the will using certificates of the witnesses and transmitting the secondary digital signature to the management server by the witness terminals; and (b3) receiving the secondary digital signature using the certificates of the witnesses from the witness terminals and verifying the secondary digital signature.

The Internet based e-will management method may further comprise the steps of: (b4) making third digital signatures on the application form and the will using the certificate of the management server and transmitting the secondary and third digital signatures to the testator/testatrix terminal, the application form and the will still including the first and second digital signatures; and (b5) verifying the third digital signature by the testator/testatrix terminal.

The Internet based e-will management method may further comprise the step of: (f) acquiring, upon advent of a renewal period for the certificate of the testator/testatrix before the expiration date thereof, a timestamp token for the application form and the will from a time stamping authority (TSA) and adding the timestamp token to the application form and the certificate, wherein, upon advent of a renewal period for the added timestamp token before the expiration date thereof, the timestamp token is reacquired.

According to still another aspect of the invention, there is provided an Internet based e-will management system which is connected to a testator/testatrix terminal via a network and a will executor terminal and in which a will is managed by making a digital signature using a certificate issued by a certificate authority, the system comprising: a will receiving section configured to receive an application form and a will which are digitally signed using a certificate of the testator/testatrix from the testator/testatrix terminal and to verify and store the digital signatures of the application form and will; a death confirmation receiving section configured to confirm the death of the testator/testatrix; and a will transmitting section configured to transmit, upon confirmation of the death of the testator/testatrix, the digitally signed will to the will executor terminal.

According to yet another aspect of the invention, there is provided an internet based e-will management system which is connected to a testator/testatrix terminal via a network and a will executor terminal and in which a will is managed by making a digital signature using a certificate issued by a certificate authority, the system comprising: a will receiving section configured to receive an application form, a will, and a secret key which are digitally signed using a certificate of the testator/testatrix and to verify and store the digital signatures of the application form, the will being encrypted using the secret key; a death confirmation receiving section configured to confirm the death of the testator/testatrix; and a will transmitting section configured to transmit, upon confirmation of the death of the testator/testatrix, the digitally signed will and the secret key to the will executor terminal.

The will receiving section may receive the secret key encrypted using a public key of the system itself, and the will transmitting section may decrypt the encrypted secret key using a private key of the system itself and may transmit the decrypted secret key.

Upon verification of the digital signature, the will receiving section may make a secondary digital signature on the application form using the certificate of the system and may transmit the secondary digital signature to the testator/testatrix terminal, the application form still including the digital signature, and wherein the secondary digital signature is verified by the testator/testatrix terminal.

The death confirmation receiving section may receive the digitally signed death certificate from a server of a death confirmation authority and may confirm the death of the testator/testatrix by verifying the digital signature of the death certificate.

When the server of the death confirmation authority is a server of a medical institution, the digitally signed death certificate may be a death certificate digitally signed using certificates of a doctor and a hospital.

The internet based e-will management system may further comprise: a witness signing section configured to transmit the digitally signed application form and will to at least two witness terminals, to receive the secondary digital signatures of the application form and the will using certificates of the witnesses from the witness terminals, and to verify the secondary digital signatures.

The Internet based e-will management system may further comprise: a long-term validating section configured to receive, upon advent of a renewal period for the certificate of the testator/testatrix before the expiration date thereof, a timestamp token for the application form and the will from a time stamping authority (TSA) and to add the timestamp token to the application form and the certificate, wherein, upon advent of a renewal period for the added timestamp token before the expiration date thereof, the timestamp token is reacquired.

As described above, according to the invention, since a will is digitally signed using a private key of the certificate of a testator/testatrix, only the testator/testatrix can make an effective signature, hereby providing non-repudiation.

Further, according to the invention, since a will management authority has a secret key for encryption of a will and a certificate authority CA has a certificate for a digital signature of the will, the secret key and the certificate (private key) can be kept separately, providing the effect of preventing the contents of the will from being revealed before the death of the testator/testatrix.

Furthermore, according to the invention, since a will written in the form of an authority and multimedia such as a voice or a video is digitally signed and managed, the testator/testatrix can write the contents of a will in any desired form.

Furthermore, according to the invention, since digital signatures can be kept for a long time using a timestamp for a digitally signed will, they can be validated for a long time even after the death of a testator/testatrix.

### BRIEF DESCRIPTION OF THE DRAWINGS

The above and other objects, features and advantages of the invention will become more apparent to those of ordinary skill in the art by describing in detail an exemplary embodiment thereof with reference to the accompanying drawings, in which:

FIGS. 1A and 1B are flowcharts explaining a conventional Internet based e-will management method;

FIGS. 2A and 2B are views illustrating a system for carrying out the invention;

FIG. 3 is a flowchart explaining an Internet based e-will management method according to the first embodiment of the invention;

FIG. 4 is a flowchart explaining an Internet based e-will management method according to the second embodiment of the invention;

FIG. 5 is a table for notations used in FIGS. 3 and 4;

FIG. 6 is a block diagram of an Internet based e-will management system according to an embodiment of the invention; and

FIG. 7 is a table comparing the effect of the Internet based e-will management system according to the invention with that of a conventional one.

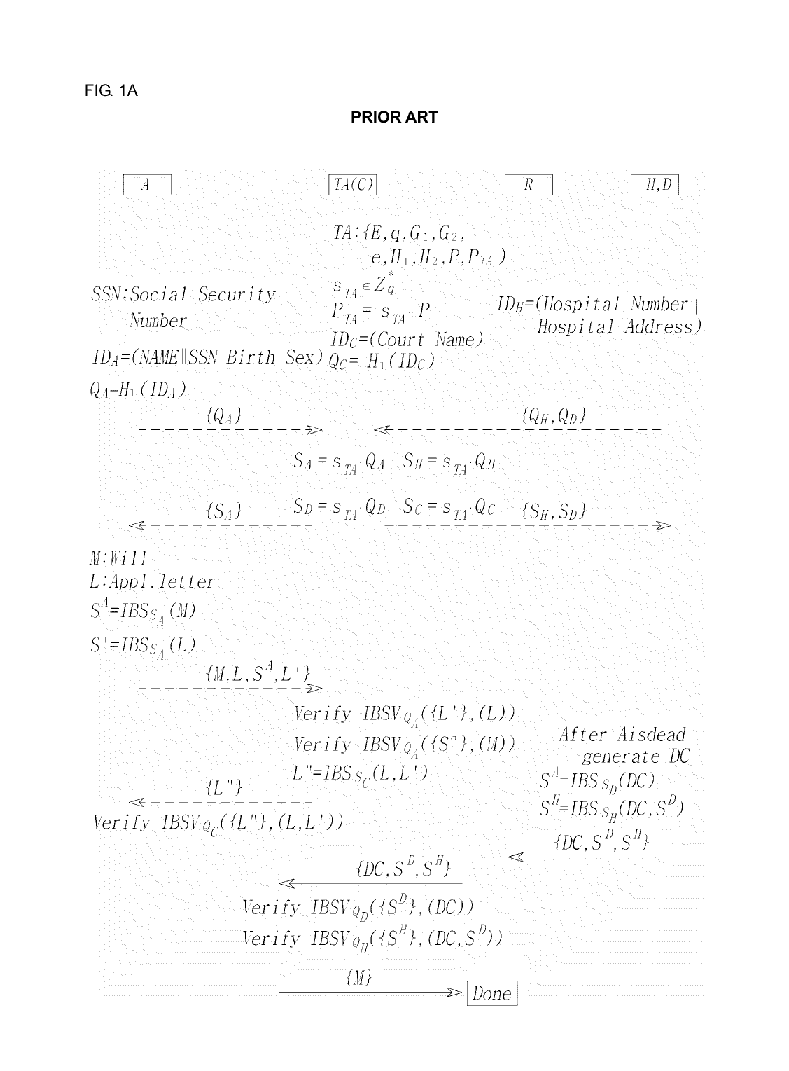

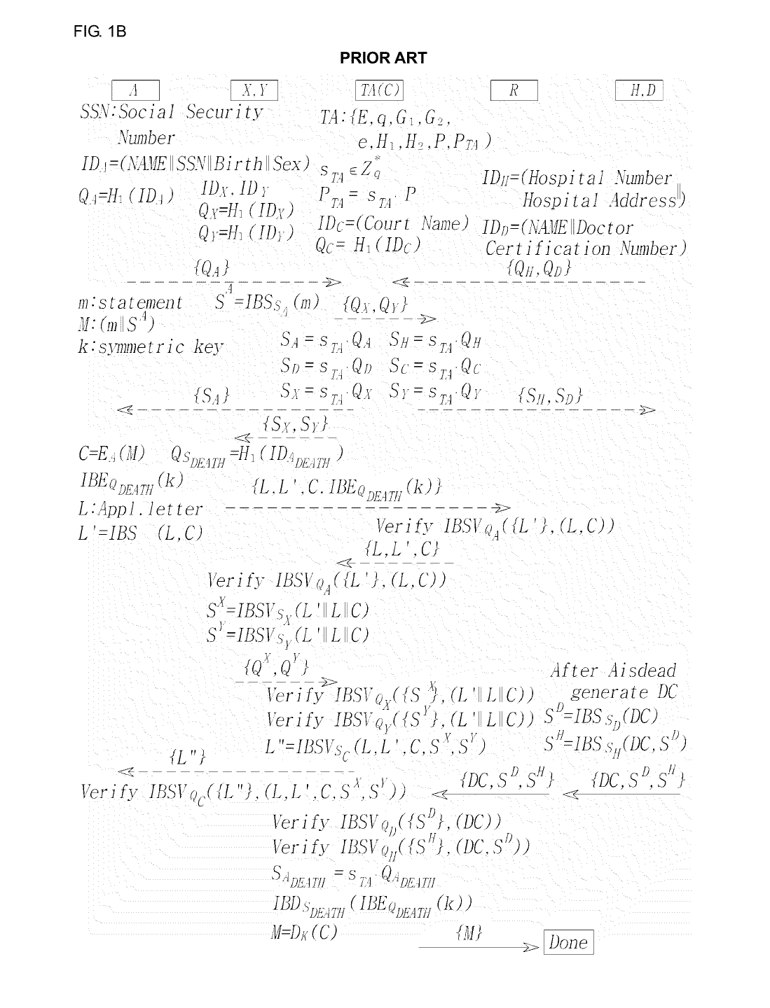

### DETAILED DESCRIPTION OF EXEMPLARY EMBODIMENTS

Hereinafter, exemplary embodiments of the invention will be described below in detail with reference to the accompanying drawings.

In the description of the invention, the same elements are endowed with the same reference numerals and are not repetitively described.

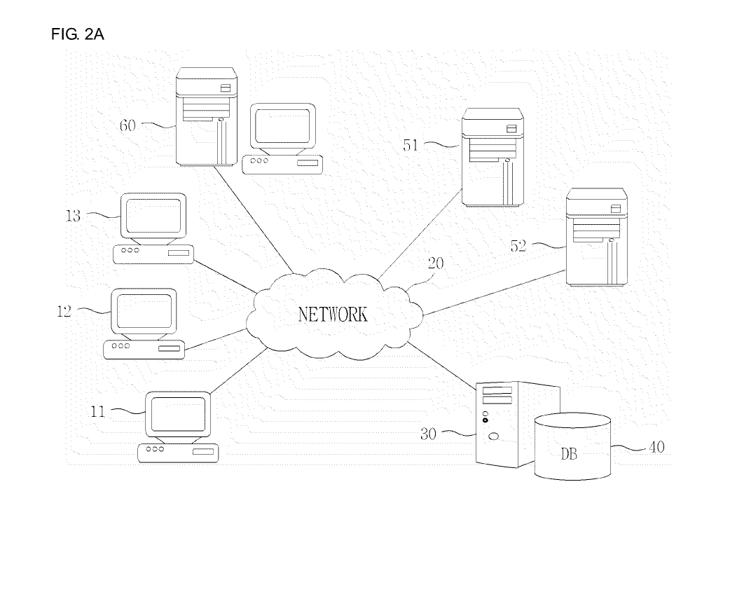

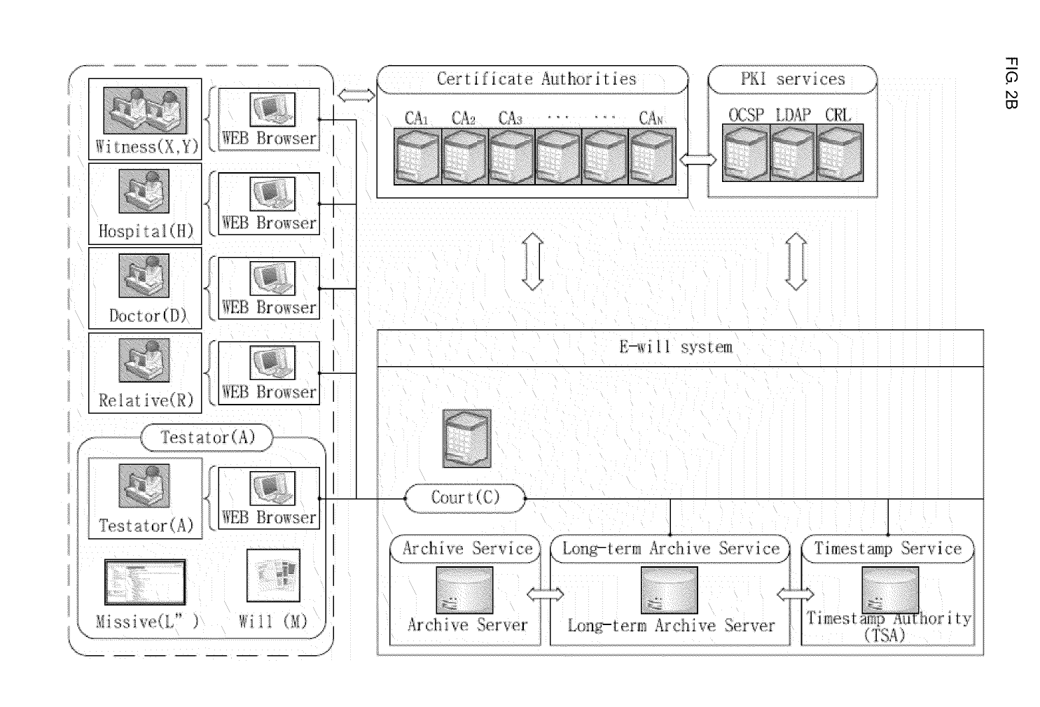

Now, an overall system for carrying out the invention will be described with reference to FIG. 2.

As can be seen in FIG. 2, the system for carrying out the invention includes a testator/testatrix terminal 11, a will executor terminal 12, a death confirmation authority server 60, a will management server 30, and a certificate authority server 51. The system may further include a testator/testatrix terminal 13 and a time stamping server 52. The servers and terminal are connected to each other via a network.

The testator terminal 11, the will executor terminal 12, or the testator/testatrix terminal 13 is a typical computing terminal such as a personal computer, a laptop computer, a net book, a PDA, or a mobile phone used by a testator/testatrix or a will executor. A testator/testatrix, a will executor, or witnesses perform will-related tasks such as drawing up a will using the terminal, receiving the will, or providing evidence. Hereinafter, the reference numerals for the testator/testatrix, the will executor, or the witnesses will be the same as those for the terminals. That is, the fact that the testator/testatrix 11 performs any work means that the work is processed through the testator/testatrix terminal 11.

Meanwhile, the will executor 12 includes heirs, relatives, and agents of the testator/testatrix who can execute the will.

The witnesses 13 are appointed by the testator/testatrix 11 to testify that the will has been drawn up by the testator/testatrix 11. Infants, interdicted persons, heirs, the heirs' spouses, and heirs' blood relatives must not be witnesses to the will.

The death confirmation authority server 60, the will management server 30, the certificate authority server 51, or the time stamping server 52 is a typical application server for providing a service to the terminals connected to each other via the network 20. The servers include a web server or a web application server for providing a service on the web.

The death confirmation authority 60 is such an authority as a medical institution or a public office which confirms the death of the testator/testatrix. In general, if a person dies, a medical institution issues a death certificate to confirm his or her death. However, if the body of a person cannot be found due to his or her disappearance or a disaster, an authority confirms his or her death.

When the death confirmation authority 60 is a medical institution, it has a responsibility to issue a digital death certificate for the dead person to his or her families or relatives. The digital death certificate is a certificate containing a name, a sex, a birth date, a blood type, a death data, a death cause, and other information on a dead person. This electronic document is signed by doctors D and a hospital H.

The certificate authority is a typical authority which issues a public key certificate or a certificate. The certificate proves that the public key pertains to an individual or a group. The duty of the certificate authority is to allow the user to confirm the information on a certificate.

The certificate of the certificate authority 51 is based on a public key infrastructure. That is, certificate status confirmation information such as an online certificate status protocol (OCSP), a certificate revocation list (CRL), or an authority revocation list (ARL) is transmitted from the certificate authority 6 to verify its effectiveness.

A time stamping authority TSA 52 creates a timestamp token for an electronic document. The timestamp token contains a hash value for the electronic document and a hash source and the certificate signature of the TSA is attached to the timestamp token. As a result, the available time for verifying the effectiveness of the electronic document may be prolonged by the available time for the certificate of the TSA. The available time may be updated by creating an additional new timestamp before the expiration date of the certificate of the TSA. Internet engineering task force (IETF) RFC3126 suggests a method of properly prolonging the availability verification period for the electronic document.

The will management server 30 is a server of an authority such as a court which manages a will and provides a will management service, for example, of keeping the written will or allowing it to be read.

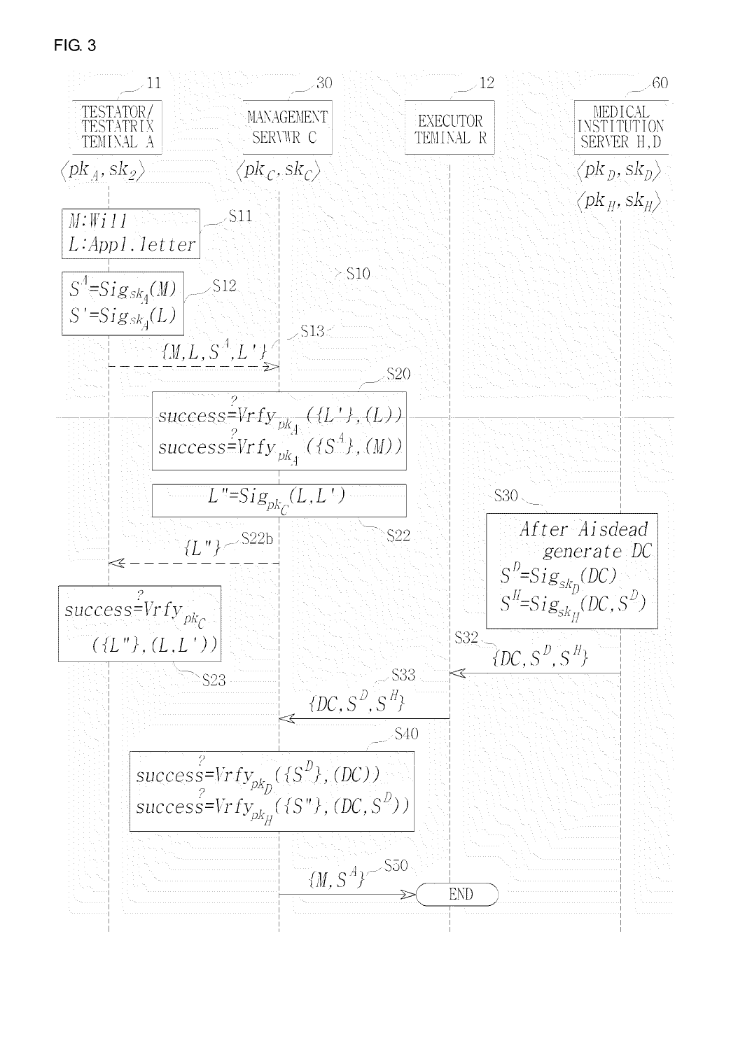

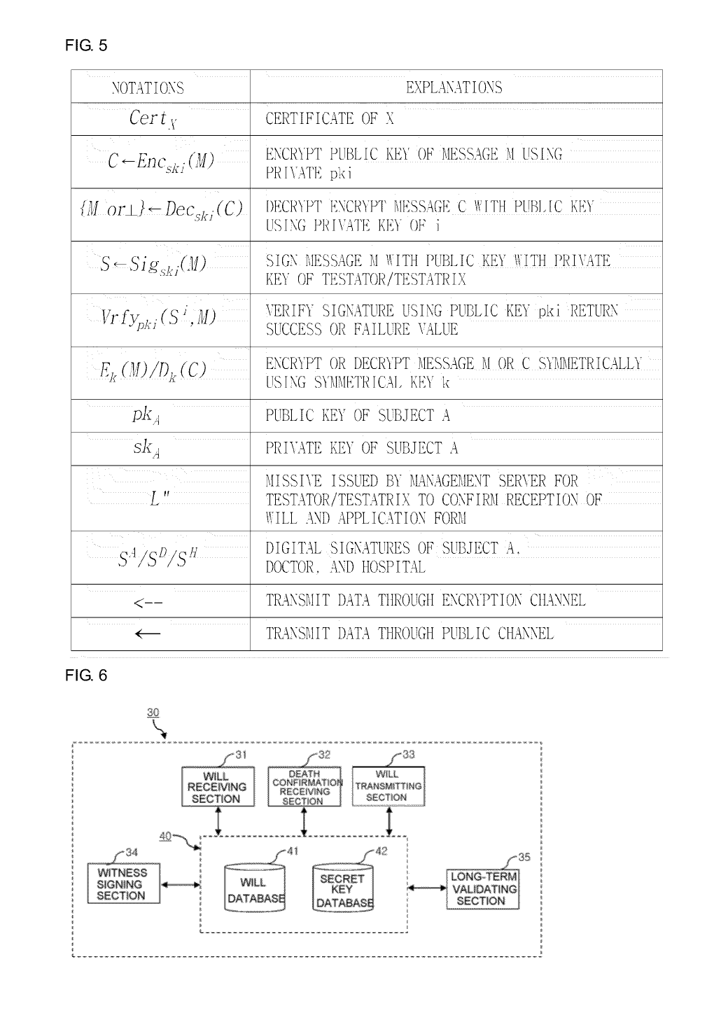

Now, an Internet based e-will management method according to the first embodiment of the invention will be described with reference to FIG. 3. FIG. 3 is a flowchart explaining the Internet based e-will management method according to the first embodiment of the invention and the notations of FIG. 3 are the same as those of FIG. 5.

As can be seen in FIG. 3, the Internet based e-will management method according to the first embodiment of the invention includes a registration step, a will creation step, a death certificate issuing and submitting step, and a will unsealing step.

(1) Registration

An enhanced e-will system uses a digital signature. The system elements A, C, H, and D create public keys pkᵢ and private keys skᵢ and certificates are issued thereto. For example, a testator/testatrix is registered in a CA and a certificate Cert_{A} is issued to him or her. Then, the certificate contains a public key.

The management server C, a doctor D, and a hospital H request certificates from a certificate authority CA, and the public key is contained in the certificates. Thus, each protocol participant has a certificate. It is assumed that the private keys are protected by personal identification numbers (PINs).

(2) Creating a Will

The testator/testatrix terminal makes a digital signature on an application form and a will using the certificate of the testator/testatrix and transmits it to the management server (S10).

The testator/testatrix A (or testator/testatrix terminal 11) fills out the will M and the application form L (S11). After the will is drawn up and a date is clarified, the testator/testatrix A makes a digital signature on the will M and the application form L (S12). Finally, the testator/testatrix A transmits the will and the application form to the management server C (S13).

The will M is written as a digital document or in the form of multimedia data. The multimedia data themselves may be the will M. The will m may be written as a digital document or multimedia data may be attached to the digital document. The multimedia data include voice data, video data, and image data.

The voice data are data obtained by recording the contents of a will of the testator/testatrix in the form of a voice. The voice data are recorded through a voice recording apparatus such as a microphone and is stored in the form of a file. The video data are data obtained recording the contents of a will of the testator/testatrix in the form of a video in which he or she speaks or takes action. The video data are recorded through a video recording apparatus such as a camcorder, a camera, or a web camera and is stored in the form of a file. The image data are data to which an autograph, a stamp, or a fingerprint is converted. The image data is stored in the form of an image file through an imaging apparatus such as a camera and a scanner.

The multimedia is written using one or more than two of the voice data, the video data, and the image data. Thus, the will M will be written in the form of one or more than two of a digital document, voice data, video data, and image data.

In the will M, the entire data including the digital document and the data are regarded as one digital data or digital document. The will M is a digital document and is digitally signed and managed. Even through the will M is described as one document or digital document hereinafter, it does not mean that the format of the data of the will is limited to a digital document.

As discussed above, the testator/testatrix selects any convenient form to draw up a will. In particular, since almost all testators/testatrixes are old and handicapped, they prefer a voice will, a video will, and an autograph will to a digital document format.

The management server 30 received the digitally signed application form and will and verifies and stores the digital signatures on the application form and the will (S20).

That is, the management server C verifies the digitally signed will M and the digitally signed application form L (S20). If the signatures are successfully verified, the management server C makes a digital signature on the application form L and provides a missive L″ to the testator/testatrix to confirm the application (S22). In other words, the management server makes a secondary digital signature on the application form using its own certificate and the application form L still includes the digital signature of the application form. The secondary digital signature is transmitted to the testator/testatrix terminal.

The testator/testatrix terminal verifies the secondary digital signature (S23).

(3) Issuing a Death Certificate (DC) to Relatives

The death confirmation authority server 60 makes a digital signature on the death certificate and transmits it to the management server 30. Then, the death certificate can be transmitted via the will executor terminal 12. When the death confirmation authority server is a medical institution server, the digitally signed death certificate is a death certificate of the testator/testatrix which has been digitally signed using the certificates of the doctor and the hospital.

That is, after the testator/testatrix dies, the doctor diagnoses the cause of death and issues a digital death certificate DC to the relatives R. The death certificate contains the digital signature S^{D} of the doctor and the digital signature S^{H} of the hospital. The hospital transmits the death certificate DC and the digital signatures S^{D} and S^{H} (S32).

In other words, the digitally signed death certificate of the testator/testatrix is created by making a first digital signature on the death certificate of the testator/testatrix using the certificate of the doctor and making a secondary digital signature on the death certificate using the certificate of the medical institution (or hospital). The death certificate still includes the first digital signature.

The relative (or will executor) submits the digital death certificate DC and the signatures S^{D} and S^{H} which have been received from the hospital to the management server (S33).

The relative can request that the will be unsealed when he or she submits the digital death certificate.

(4) Verifying a Digital Death Certificate (DC) by a Management Server

The management server C verifies the digital death certificate DC and the signatures S^{D} and S^{H} of the doctor and the hospital. The verification method is as follows.

VrFy_{pkD}({S^{D}},DC)) and Vrfy_{pkH}({S^{H}}, (DC,S^{D})))

If the digital death certificate DC and the digital signatures are properly verified, the next step is performed.

(5) Unsealing a Will by a Management Server

The management server transmits the will M and the digital signature SA of the testator/testatrix to the relative of the testator/testatrix (S50).

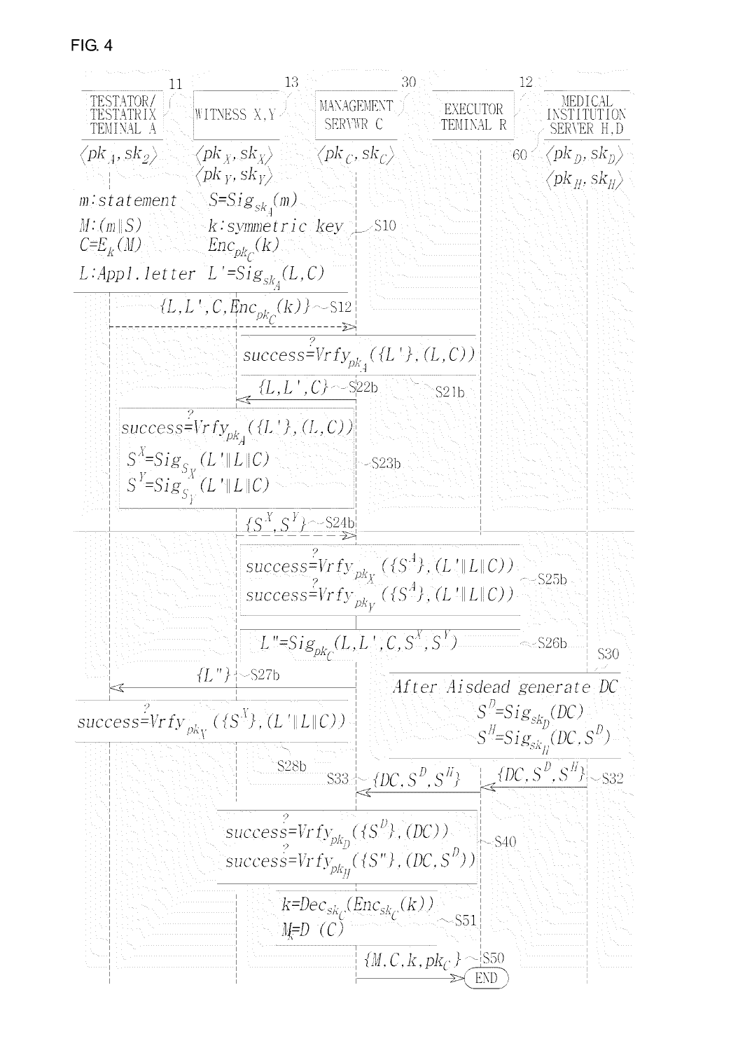

Now, an Internet based e-will management method according to the second embodiment of the invention will be described with referring to FIG. 4. FIG. 4 is a flowchart explaining an Internet based e-will management method according to the second embodiment of the invention and the notations of FIG. 4 are the same as those of FIG. 5.

(1) Registration

This step is the same as in the first embodiment of the invention.

(2) Creating a Will

The testator/testatrix terminal 11 makes digital signatures on an application form and a will using the certificate of the testator/testatrix and transmits them to the management server 30 together with a secret key. Then, the will is encrypted using the secret key.

That is, the testator/testatrix A fills out an application form L and obtains a sealed will C after the contents of the will are encrypted using a symmetric key k. The symmetric key k is encrypted to the public key pk_{C} of the management server using a public key encryption algorithm.

The will M is written as a digital document or in the form of multimedia data. The multimedia data themselves may be the will M. The will m may be written as a digital document or multimedia data may be attached to the digital document. The multimedia data include voice data, video data, and image data.

The voice data are data obtained by recording the contents of a will of the testator/testatrix in the form of a voice. The voice data are recorded through a voice recording apparatus such as a microphone and is stored in the form of a file. The video data are data obtained recording the contents of a will of the testator/testatrix in the form of a video in which he or she speaks or takes action. The video data are recorded through a video recording apparatus such as a camcorder, a camera, or a web camera and is stored in the form of a file. The image data are data to which an autograph, a stamp, or a fingerprint is converted. The image data is stored in the form of an image file through an imaging apparatus such as a camera and a scanner.

The multimedia is written using one or more than two of the voice data, the video data, and the image data. Thus, the will M will be written in the form of one or more than two of a digital document, voice data, video data, and image data.

In the will M, the entire data including the digital document and the data are regarded as one digital data or digital document. The will M is a digital document and is digitally signed and managed. Even through the will M is described as one document or digital document hereinafter, it does not mean that the format of the data of the will is limited to a digital document.

Next, the testator/testatrix A makes a digital signature on the application form L and the sealed will C. The testator/testatrix transmits the sealed will C, the encrypted symmetric key Enc_{pkC}(k), and the application form L to the management server C (S12).

The management server verifies that the digital signature of the testator/testatrix is properly included (S21b).

Next, the sealed will C and the application form L are transmitted to at least two witnesses X and Y designated by the testator/testatrix, excluding the testator/testatrix, to obtain digital signatures of the witnesses X and Y. If the management server receives the sealed will C and the application form L from the witnesses (S23b), it is verified that the two witnesses X and Y properly have signed the will C and the application form L written by the testator/testatrix A (S25b).

That is, the management server 30 transmits the digitally signed application form and will to the at least two testator/testatrix terminals 13, and the testator/testatrix terminals 13 make secondary digital signatures on the application form and the will using the certificates of the witnesses and transmit them to the management server (S24b). The management server 30 receives the secondary digital signatures of the testator/testatrix 13 using the certificates of the witness terminals 13 to verify them (S25b).

The management server makes third digital signatures on the application form and the will using its own certificate and the application form and the will still include the first digital signatures and the second digital signatures. The management server transmits the secondary digital signatures and the third digital signatures to the testator/testatrix terminal (S27b). The testator/testatrix terminal 11 verifies the third digital signatures (S28b).

(3) Issuing a Death Certificate (DC) to Relatives

After the testator/testatrix dies, the doctor diagnoses the cause of death and issues a digital death certificate DC to the relatives R. The death certificate contains the digital signature S^{D} of the doctor and the digital signature S^{H} of the hospital. The hospital transmits the death certificate DC and the digital signatures S^{D} and S^{H} (S32).

The relative submits the digital death certificate DC and the signatures S^{D} and S^{H} which have been received from the hospital to the management server (S33). The relative can request that the will be unsealed when he or she submits the digital death certificate.

(4) Verifying a Digital Death Certificate (DC) by a Management Server

The management server C verifies the digital death certificate DC and the signatures S^{D} and S^{H} of the doctor and the hospital. The verification method is as follows.

VrFy_{pkD}({S^{D}},DC)) and Vrfy_{pkH}({S^{H}},(DC,S^{D})))

If the digital death certificate DC and the digital signatures are properly verified, the next step is performed.

(5) Unsealing a Will by a Management Server

The management server uses a private key sk_{C} to decrypt the encrypted symmetric key k (S51). After the sealed will C is decrypted using the symmetric key k, the contents of the will, the electronic signature S^{A} of the testator/testatrix, and the public key pk_{C} of the management server are transmitted to the relative (S50).

Now, an Internet based e-will management system according to an embodiment of the invention will be described with reference to FIG. 6.

In the embodiment of the invention, the Internet based e-will management system may be an e-will management server 30 connected to a testator/testatrix terminal 11, a will executor terminal 12, and a death confirmation authority 60 via a network 20.

As can be seen in FIG. 6, the Internet based e-will management system according to the embodiment of the invention includes a will receiving section 31, a death confirmation receiving section 32, and a will transmitting section 33. The system may further include a witness signing section 34 and a long-term validating section 35.

As an example, the will receiving section 31 receives the application form and the will digitally signed using the certificate of the testator/testatrix from the testator/testatrix terminal 11 and verifies and stores the digital signatures of the application form and the will.

As another example, the will receiving section 31 receives the application form and the will digitally signed using the certificate of the testator/testatrix and the secret key from the testator/testatrix terminal 11 and verifies and stores the digital signatures of the application and the will. Then, the will is encrypted using the secret key. Specifically, the will receiving section receives the secret key encrypted using the public key of the system itself.

Meanwhile, if the digital signatures are verified, the will receiving section 31 makes a secondary digital signature on the application form using the certificate of the system, the application form still including the digital signature of the application form, and transmits the secondary digital signature to the testator/testatrix terminal. The secondary digital signature is verified by the testator/testatrix terminal 11.

The death confirmation receiving section 32 receives the digitally signed death certificate from the death confirmation authority server 60 and verifies the digital signature of the death certificate.

Meanwhile, when the death confirmation authority server 60 is a medical institution server, the digitally signed death certificate is a death certificate of the testator/testatrix digitally signed by the certificates of the doctor and the hospital.

If the will transmitting section 33 receives a will reading request from the will executor terminal 12 after receiving the death certificate, it transmits the digitally signed will.

As another example, the will transmitting section 33 further includes a secret key when it transmits a will. In particular, the will transmitting section 33 decrypts the encrypted secret key using the private key of the system itself when it transmits a will.

The witness signing section 34 transmits the digitally signed application form and will to at least two witness terminal 13, receives the secondary digital signatures using the certificates of the witnesses from the witness terminals 13, and verifies the secondary digital signatures.

Upon advent of a renewal period for the certificate of the testator/testatrix before the expiration date thereof, the long-term validating section 31 acquires a timestamp token for the application form and the will from a time stamping authority (TSA) server 52 and adds it to the application form and the certificate. Upon advent of a renewal period for the added timestamp token, the timestamp token is reacquired.

The omitted description of the Internet based e-will management system may be understood with reference to the above-described Internet based e-will management method.

Now, a long-term validating method for digital signatures of a will according to an embodiment of the invention will be described in detail.

The security of the Internet based e-will management system and method according to the invention is based on digital signatures written on a will and an application form which are digitally drawn up. In general, the integrity of a digital document is secured by a digital signature. However, it becomes difficult to absolutely secure the reliability of a digital signature over time. After a long time period of time, a hash algorithm and a public key algorithm may become vulnerable and certificates may become unavailable. In order to solve this problem, a long-term validating method for a digital signature is required.

In order to enable long-term signature validation for a digital signature, it is essential to prove that digitally signed data have already existed before a certificate becomes unavailable. However, a timestamp has the same problem as a digital signature. In order to solve this problem, a new timestamp should be obtained before the existing timestamp becomes unavailable. Then, the existing original data and the timestamp therefor should be renewed.

That is, upon advent of a renewal period for the certificate of the testator/testatrix before the expiration date thereof, the management server 30 acquires a timestamp token for the application form and the will from a time stamping authority (TSA) server 52 and adds it to the application form and the certificate. Upon advent of a renewal period for the added timestamp token, the timestamp token is reacquired.

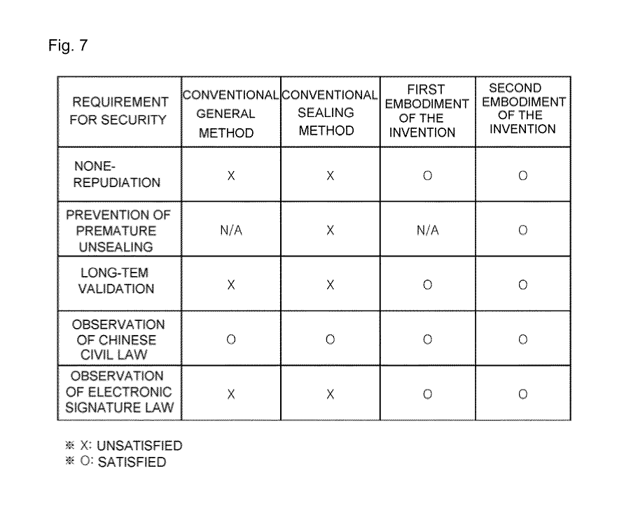

Now, the effects of the Internet based e-will management system and method according to the invention will be described in more detail with reference to FIG. 7.

The Internet based e-will management system and method according to the invention have the following effects in terms of non-repudiation, prevention of premature unsealing, and long-term validation.

In order to satisfy non-repudiation security requirements, the contents of the will cannot be repudiated. In the Internet based e-will management system and method, the will should be created and corrected only by the actual testator/testatrix. In the method of Chien et al., the TA can easily calculate or recognize a private key. Thus, the TA can create the digital signatures of the testator/testatrix and the witnesses. This means that the TA can forge the will. However, according to the invention, since only the testator/testatrix has his or her private key, he or she alone can create an effective signature. Moreover, if the testator/testatrix dies, no one can correct the contents of the will. Meanwhile, the digital signatures of the will can be verified using an opened parameter. Thus, the present invention provides non-repudiation.

In the sealed e-will system, no one should be informed of the contents of the will before a hospital issues a death certificate after the testator/testatrix dies according to the requirement for prevention of premature unsealing. However, in the method of Chien et al. which uses an ID based cryptosystem, the TA can know the private key of a management server. Thus, the TA can decrypt the sealed will. As a result, the method of Chien et al. fails to provide a means for preventing premature unsealing. Meanwhile, since the method of the invention is based on a public key infrastructure, the CA is separated from the management server. In other words, since only the management server can decrypt the sealed will, the contents of the will cannot be revealed before the death of the testator/testatrix. Thus, the invention prevents premature unsealing.

If a long time passes, a hash algorithm and a public key algorithm may become vulnerable, and the certificate becomes unavailable. Therefore, the e-will system requires a method of validating digital signatures after the testator/testatrix dies. The invention suggests a long-term validation method for digital signatures of the will. Thus, the invention satisfies the long-term signature validation requirements.

The invention may be applied to development of an Internet based e-will management system in which digital signatures are made on an application form and a will using certificates issued by certificate authorities to provide non-repudiation. In particular, the invention is useful in development of an Internet based e-will management system in which digital signatures are kept for a long time using a timestamp for an e-will which was digitally signed before the expiration date of a certificate used in the digitally signed will.

It will be apparent to those skilled in the art that various modifications can be made to the above-described exemplary embodiment of the invention without departing from the spirit or scope of the invention. Thus, it is intended that the invention covers all such modifications provided they come within the scope of the appended claims and their equivalents.

What is claimed is:

1. An Internet based e-will management method in which a will is managed by making digital signatures using a certificate issued by a certificate authority through a will management server connected to a testator/testatrix terminal and a will executor terminal via a network, the method comprising:
(a) making digital signatures on an application form and a will using a certificate by a testator/testatrix through the testator/testatrix terminal and transmitting the digitally signed application form and will to the management server by the testator/testatrix terminal;
(b) receiving the digitally signed application form and will and verifying and storing the digital signatures of the application form and will by the management server;
(c) confirming the death of the testator/testatrix by the management server; and
(d) transmitting, upon confirmation of the death of the testator/testatrix, the digitally signed will to the will executor terminal by the management server.

2. The Internet based e-will management method of claim 1, further comprising the steps of:
(b2) making a secondary digital signature on the application form using the certificate of the management server and transmitting the secondary digital signature to the testator/testatrix terminal by the management server after step (b), the application form still including the digital signature on the application form; and
(b3) verifying the secondary digital signature by the testator terminal.

3. The Internet based e-will management method of claim 1, wherein in step (c), the management server receives a digitally signed death certificate from a server of a death confirmation authority and confirms the death of the testator/testatrix by verifying the digital signature of the death certificate.

4. The Internet based e-will management method of claim 3, wherein in step (c), the digitally signed death certificate is transmitted via the will executor terminal.

5. The Internet based e-will management method of claim 3, wherein when the server of the death confirmation authority is a server of a medical institution, the digitally signed death certificate is a death certificate digitally signed using certificates of a doctor and a hospital.

6. The Internet based e-will management method of claim 5, wherein the digitally signed death certificate of the testator/testatrix is created by making a first digital signature on the death certificate of the testator/testatrix using the certificate of the doctor and making a secondary digital signature on the death certificate using the certificate of the medical institution, the death certificate still including the first digital signature.

7. The Internet based e-will management method of claim 1, further comprising the steps of:
(b1) transmitting the digitally signed application form and will to at least two witness terminals by the management server after step (b);
(b2) making secondary digital signatures on the application form and the will using certificates of the witnesses and transmitting the secondary digital signature to the management server by the witness terminals; and
(b3) receiving the secondary digital signature using the certificates of the witnesses from the witness terminals and verifying the secondary digital signature.

8. The Internet based e-will management method of claim 7, further comprising steps of:
(b4) making third digital signatures on the application form and the will using the certificate of the management server and transmitting the secondary and third digital signatures to the testator/testatrix terminal, the application form and the will still including the first and second digital signatures; and
(b5) verifying the third digital signature by the testator/testatrix terminal.

9. The Internet based e-will management method of claim 1, further comprising the step of:
(f) acquiring, upon advent of a renewal period for the certificate of the testator/testatrix before an expiration date thereof, a timestamp token for the application form and the will from a time stamping authority (TSA) and adding the timestamp token to the application form and the certificate,
wherein, upon advent of a renewal period for the added timestamp token before the expiration date thereof, the timestamp token is reacquired.

10. The Internet based e-will management method of claim 1, wherein the will contains multimedia data.

11. The Internet based e-will management method of claim 10, wherein the multimedia data contains at least one of voice data, video data, and image data.

12. An Internet based e-will management method in which a will is managed by making digital signatures using a certificate issued by a certificate authority through a will management server connected to a testator/testatrix terminal and a will executor terminal via a network, the method comprising the step of:
(a) making digital signatures on an application form and a will using a certificate by a testator/testatrix through the testator/testatrix terminal and transmitting the digitally signed application form and will to the management server together with a secret key for encrypting the will by the testator/testatrix terminal;
(b) receiving the digitally signed application form and will and the secret key and verifying and storing the digital signatures of the application form and will by the management server;
(c) confirming the death of the testator/testatrix by the management server; and
(d) transmitting, upon confirmation of the death of the testator/testatrix, the digitally signed will and the secret key to the will executor terminal by the management server.

13. The Internet based e-will management method of claim 12, wherein in step (a), the testator/testatrix terminal encrypts the secret key using a public key of the management server, and in step (d), the management server decrypts the encrypted secret key using its own private key and transmits the decrypted secret key.

14. The Internet based e-will management method of claim 12, wherein in step (c), the management server receives a digitally signed death certificate from a server of a death confirmation authority and confirms the death of the testator/testatrix by verifying the digital signature of the death certificate.

15. An Internet based e-will management system which is connected to a testator/testatrix terminal via a network and a will executor terminal and in which a will is managed by making a digital signature using a certificate issued by a certificate authority, the system comprising:
a will receiving section configured to receive an application form and a will which are digitally signed using a certificate of the testator/testatrix from the testator/testatrix terminal and to verify and store the digital signatures of the application form and will;
a death confirmation receiving section configured to confirm the death of the testator/testatrix; and
a will transmitting section configured to transmit, upon confirmation of the death of the testator/testatrix, the digitally signed will to the will executor terminal.

16. The Internet based e-will management system of claim 15, wherein upon verification of the digital signature, the will receiving section makes a secondary digital signature on the application form using the certificate of the system and transmits the secondary digital signature to the testator/testatrix terminal, the application form still including the digital signature of the application form, and wherein the secondary digital signature is verified by the testator/testatrix terminal.

17. The Internet based e-will management system of claim 15, wherein the death confirmation receiving section receives the digitally signed death certificate from a server of a death confirmation authority and confirms the death of the testator/testatrix by verifying the digital signature of the death certificate.

18. The Internet based e-will management system of claim 17, wherein, when the server of the death confirmation authority is a server of a medical institution, the digitally signed death certificate is a death certificate digitally signed using certificates of a doctor and a hospital.

19. The Internet based e-will management system of claim 15, further comprising:
a witness signing section configured to transmit the digitally signed application form and will to at least two witness terminals, to receive the secondary digital signatures of the application form and the will using certificates of the witnesses from the witness terminals, and to verify the secondary digital signatures.

20. The Internet based e-will management system of claim 15, further comprising:
a long-term validating section configured to receive, upon advent of a renewal period for the certificate of the testator/testatrix before the expiration date thereof, a timestamp token for the application form and the will from a time stamping authority (TSA) and to add the timestamp token to the application form and the certificate,
wherein, upon advent of a renewal period for the added timestamp token before the expiration date thereof, the timestamp token is reacquired.

21. The Internet based e-will management system of claim 20, wherein the will contains multimedia data.

22. An Internet based e-will management system which is connected to a testator/testatrix terminal via a network and a will executor terminal and in which a will is managed by making a digital signature using a certificate issued by a certificate authority, the system comprising:
a will receiving section configured to receive an application form, a will, and a secret key which are digitally signed using a certificate of the testator/testatrix and to verify and store the digital signatures of the application form, the will being encrypted using the secret key;
a death confirmation receiving section configured to confirm the death of the testator/testatrix; and
a will transmitting section configured to transmit, upon confirmation of the death of the testator/testatrix, the digitally signed will and the secret key to the will executor terminal.

23. The Internet based e-will management system of claim 22, wherein the will receiving section receives the secret key encrypted using a public key of the system, and wherein the will transmitting section decrypts the encrypted secret key using a private key of the system and transmits the decrypted secret key.
